(19) United States
(12) Patent Application Publication
(10) Pub. No.: US 2026/0180227 A1
(43) Pub. Date: Jun. 25, 2026

(54) CONNECTOR

(71) Applicant: Bellwether Electronic Corp., Taoyuan City (TW)

(72) Inventors: Jimmy Enrique ACERA, Taoyuan City (TW); Li-Yong BAI, Jiangsu (CN); Xin DU, Jiangsu (CN)

(21) Appl. No.: 19/356,200

(22) Filed: Oct. 13, 2025

(30) Foreign Application Priority Data
Dec. 25, 2024 (CN) 202423211005.7

(51) Int. Cl. H01R 13/424

(52) U.S. Cl. CPC H01R 13/424

(57) ABSTRACT

A connector includes an insulating housing and at least one conductive component. The insulating housing includes an outer casing, at least one first guiding portion and at least one first snapping portion. The outer casing defines an accommodation space and a first opening communicated with the accommodation space. The first guiding portion and the first snapping portion are respectively connected to the outer casing. The conductive component includes a conductive body, a second guiding portion and a second snapping portion. The conductive body is at least partially located in the accommodation space and penetrates through the first opening. The second guiding portion and the second snapping portion are respectively disposed on the conductive body. The second guiding portion is configured to couple with the first guiding portion. The second snapping portion is configured to snap with the first snapping portion.

### RELATED APPLICATIONS

This application claims priority to Chinese Application Serial Number 202423211005.7, filed December 25, 2024, which is herein incorporated by reference in its entirety.

### BACKGROUND

### Technical Field

The present disclosure relates to a connector, and more particularly to a power connector.

### Description of Related Art

As the pace of modern life continues to accelerate, the demand for electronic devices has been steadily increasing. Facing to a huge consumer market, manufacturers are not only focused on enhancing the functionality and performance of their products but also striving hard to improve the reliability and stability of electronic devices in order to boost the market competitiveness of their brands.

Taking power connectors as an example, the measure to effectively simplify the assembly methods at low costs while improving the structural stability of their internal components is undoubtedly an important issue that the industry highly concerns about.

### SUMMARY

A technical aspect of the present disclosure is to provide a connector, which can optimize the installation convenience and enhance the structural stability.

According to an embodiment of the present disclosure, a connector includes an insulating housing and at least one conductive component. The insulating housing includes an outer casing, at least one first guiding portion and at least one first snapping portion. The outer casing defines an accommodation space and a first opening communicated with the accommodation space. The first guiding portion and the first snapping portion are respectively connected to the outer casing. The conductive component includes a conductive body, a second guiding portion and a second snapping portion. The conductive body is at least partially located in the accommodation space and penetrates through the first opening. The second guiding portion and the second snapping portion are respectively disposed on the conductive body. The second guiding portion is configured to couple with the first guiding portion. The second snapping portion is configured to snap with the first snapping portion.

In one or more embodiments of the present disclosure, the conductive body includes a terminal portion and a conductive portion. The conductive portion is connected with the terminal portion. The terminal portion at least partially penetrates through the first opening. The second snapping portion is disposed on the terminal portion. The conductive portion is connected between the second guiding portion and the terminal portion.

In one or more embodiments of the present disclosure, the terminal portion at least partially extends along a mating direction and penetrates through the first opening along the mating direction. The first guiding portion and the second guiding portion at least partially extend along the mating direction respectively.

In one or more embodiments of the present disclosure, the first guiding portion includes a plurality of limiting members. The limiting members are located in the accommodation space and at least partially extend along the mating direction respectively. The limiting members collectively define a limiting space therein. The second guiding portion includes a first fixing member and at least one guiding member. The guiding member is connected with the first fixing member. The first fixing member is connected to the conductive portion. The guiding member at least partially extends along the mating direction. The guiding member is at least partially located in the limiting space and abuts against the limiting members.

In one or more embodiments of the present disclosure, the guiding member has a first cross-sectional profile. The first cross-sectional profile is perpendicular to the mating direction and at least partially bent in shape.

In one or more embodiments of the present disclosure, the first snapping portion is plate-shaped and connected to at least one of the limiting members. The first snapping portion has an abutting surface. The abutting surface at least partially faces to the first opening. The second snapping portion includes a second fixing member and at least one elastic sheet. The second fixing member is connected to the terminal portion. The elastic sheet at least partially protrudes relative to the terminal portion. The elastic sheet has a fixed end and a free end opposite to the fixed end. The fixed end is connected to the second fixing member. The elastic sheet is configured to be pressed against the first snapping portion to elastically deform, in order to allow the free end to pass over the first snapping portion and be suitable to abut against the abutting surface after passing over the first snapping portion.

In one or more embodiments of the present disclosure, the outer casing further includes at least one second opening. The second opening is communicated with the accommodation space and at least partially aligned with the elastic sheet.

In one or more embodiments of the present disclosure, the terminal portion includes an outer terminal, an inner terminal and a conductive sheet. The conductive sheet is at least partially sandwiched between the outer terminal and the inner terminal. The outer terminal is connected to the conductive portion. The second snapping portion is disposed on a side of the outer terminal facing away from the inner terminal.

In one or more embodiments of the present disclosure, the conductive component is configured to be at least partially inserted into the accommodation space along a mating direction and penetrate through the first opening. The outer casing has a second cross-sectional profile. The second cross-sectional profile is perpendicular to the mating direction and at least partially shaped as a rectangular frame. The first guiding portion is located within the second cross-sectional profile and at least partially aligned with the second guiding portion.

In one or more embodiments of the present disclosure, the conductive body includes a terminal portion and a conductive portion. The terminal portion at least partially penetrates through the first opening along a mating direction. The second snapping portion is disposed on the terminal portion. The second guiding portion is at least partially connected between the terminal portion and the conductive portion. The second guiding portion has at least one groove. The first guiding portion and the groove respectively extend along the mating direction. The groove is configured to at least partially accommodate the first guiding portion.

In one or more embodiments of the present disclosure, the first snapping portion is plate-shaped and has an abutting surface. The abutting surface at least partially faces to the first opening. The second snapping portion includes a second fixing member and at least one elastic sheet. The second fixing member is connected to the terminal portion. The elastic sheet at least partially protrudes relative to the terminal portion. The elastic sheet has a fixed end and a free end opposite to the fixed end. The fixed end is connected to the second fixing member. The elastic sheet is configured to be pressed against the first snapping portion to elastically deform, in order to allow the free end to pass over the first snapping portion and be suitable to abut against the abutting surface after passing over the first snapping portion.

In one or more embodiments of the present disclosure, the outer casing has two guiding plates. The two guiding plates are opposite and spaced apart from each other. The two guiding plates define the accommodation space therebetween. A quantity of the first guiding portion and a quantity of the conductive component are respectively plural. Each of the two guiding plates is connected between two of the first guiding portions along a limiting direction perpendicular to the mating direction. The second guiding portion of each of the conductive components is configured to be at least partially located between the two guiding plates. The conductive portion of each of the conductive components is configured to be located outside the outer casing.

According to an embodiment of the present disclosure, a connector includes an insulating housing and at least one conductive component. The insulating housing includes an outer casing, at least one internal structure and at least one first guiding portion. The outer casing defines an accommodation space and an opening communicated with the accommodation space. The internal structure is connected with the outer casing and located in the accommodation space. The internal structure has a first side and a second side opposite to the first side. The internal structure forms a voided space at the first side. The first guiding portion is disposed on the second side. The conductive component includes a conductive portion, a terminal portion, a second guiding portion and a snapping portion. The terminal portion and the second guiding portion are disposed on opposite sides of the conductive portion. The snapping portion is disposed on a side of the terminal portion facing to the second guiding portion. The conductive portion is located in the accommodation space and at least partially aligns with the internal structure along a mating direction. The terminal portion penetrates through the opening along the mating direction. The second guiding portion is configured to couple with the first guiding portion. The snapping portion is configured to be at least partially located in the voided space and elastically snapped with the internal structure.

In one or more embodiments of the present disclosure, the first guiding portion and the second guiding portion at least partially extend along the mating direction.

In one or more embodiments of the present disclosure, the snapping portion includes a fixing member and at least one elastic sheet. The elastic sheet is connected with the fixing member. The fixing member is connected with the terminal portion. The elastic sheet is connected with the fixing member and at least partially inclined relative to the terminal portion along the mating direction. The elastic sheet is located between the fixing member and the conductive portion. The elastic sheet is spaced apart from the conductive portion.

In one or more embodiments of the present disclosure, the elastic sheet is at least partially located between the terminal portion and the second guiding portion.

### BRIEF DESCRIPTION OF THE DRAWINGS

The disclosure can be more fully understood by reading the following detailed description of the embodiments, with reference made to the accompanying drawings as follows:

FIG. 1 is a perspective schematic view of a connector according to an embodiment of the present disclosure;

FIG. 2 is a perspective bottom view of the insulating housing of FIG. 1, in which the conductive component is not shown;

FIG. 3 is a perspective schematic view of the conductive component of FIG. 1, in which the insulating housing is not shown;

FIG. 4 is a sectional view along the sectional line A-A of FIG. 1;

FIG. 5 is a sectional view along the sectional line B-B of FIG. 1;

FIG. 6 is a perspective schematic view of a connector according to another embodiment of the present disclosure;

FIG. 7 is a perspective schematic view of the connector of FIG. 6, in which the insulating housing and the conductive component are separated from each other; and

FIG. 8 is a sectional view along the sectional line C-C of FIG. 6.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

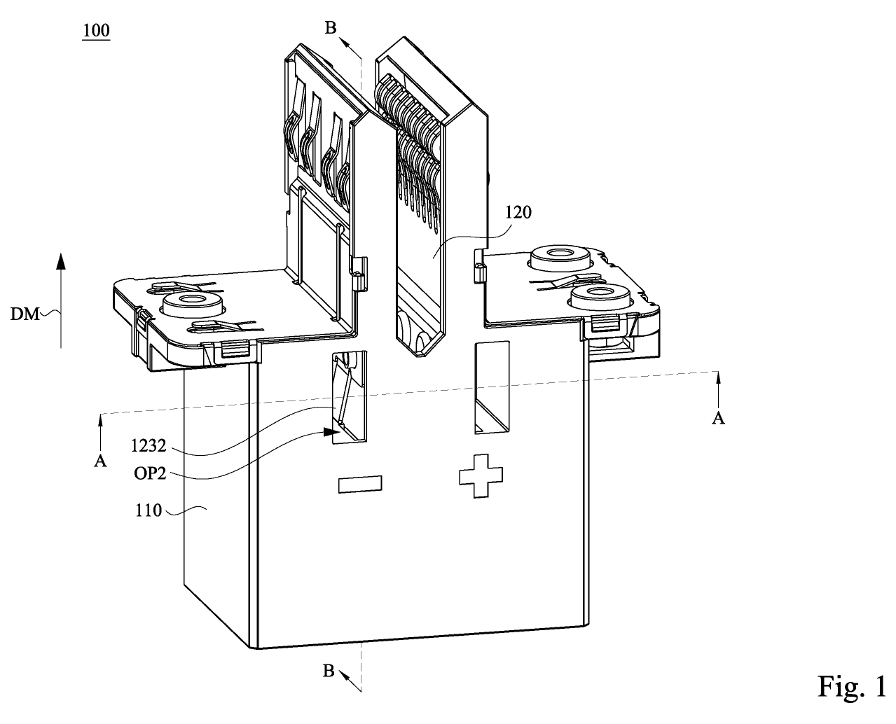

Reference is made to FIG. 1. FIG. 1 is a perspective schematic view of a connector 100 according to an embodiment of the present disclosure. In this embodiment, as shown in FIG. 1, a connector 100 includes an insulating housing 110 and at least one conductive component 120. The conductive component 120 is configured to be inserted along a mating direction DM and disposed within the insulating housing 110, and the conductive component 120 is configured to electrically contact a busbar (not shown).

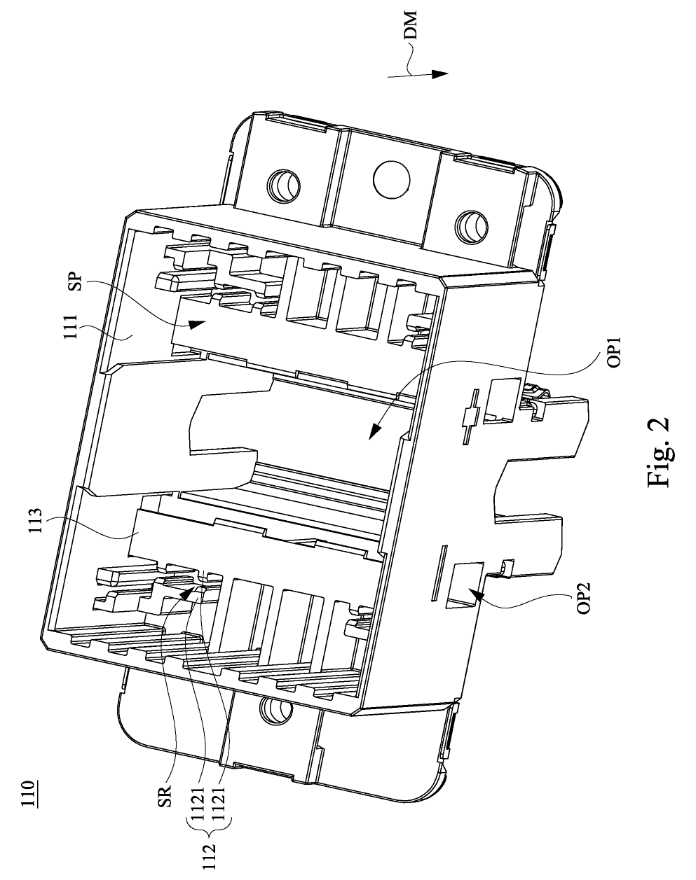

Please refer to FIG. 2. FIG. 2 is a perspective bottom view of the insulating housing 110 of FIG. 1, in which the conductive component 120 is not shown. In this embodiment, as shown in FIG. 2, the insulating housing 110 includes an outer casing 111, at least one first guiding portion 112 and at least one first snapping portion 113. The outer casing 111 defines an accommodation space SP and a first opening OP1 communicated with the accommodation space SP. The first guiding portion 112 and the first snapping portion 113 are respectively located in the accommodation space SP and connected with the outer casing 111. The first guiding portion 112 at least partially extends along the mating direction DM.

More specifically, as shown in FIG. 2, the first guiding portion 112 of the insulating housing 110 includes a plurality of limiting members 1121. The limiting members 1121 at least partially extend along the mating direction DM respectively. The limiting members 1121 at least partially surround to collectively define a limiting space SR therein. Furthermore, the first snapping portion 113 is connected to at least one of the limiting members 1121.

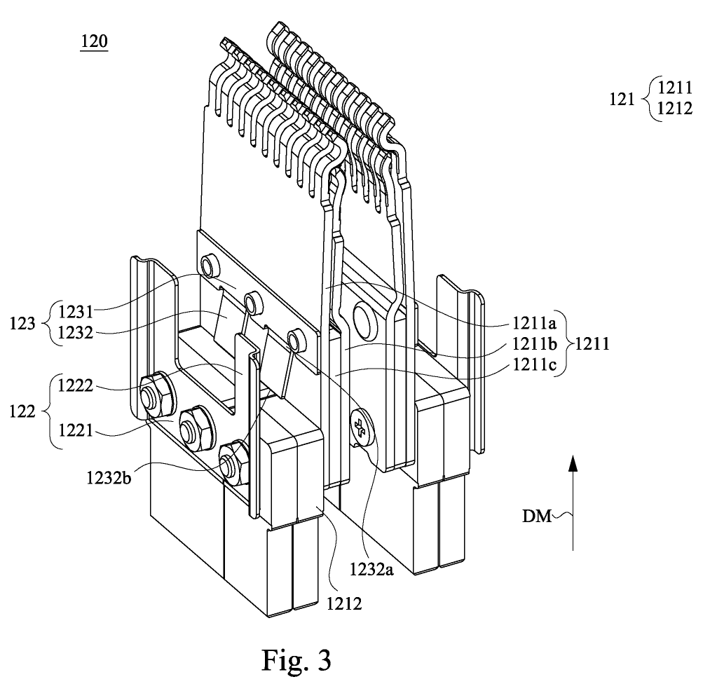

Please refer to FIG. 3. FIG. 3 is a perspective schematic view of the conductive component 120 of FIG. 1, in which the insulating housing 110 is not shown. In this embodiment, as shown in FIG. 3, the conductive component 120 includes a conductive body 121, a second guiding portion 122 and a second snapping portion 123. The second guiding portion 122 and the second snapping portion 123 are respectively disposed on the conductive body 121. The second guiding portion 122 at least partially extends along the mating direction DM and is configured to couple with the first guiding portion 112 of the insulating housing 110. The second snapping portion 123 is configured to snap with the first snapping portion 113 of the insulating housing 110.

More specifically, as shown in FIG. 3, a quantity of the conductive body 121 is a pair. The conductive bodies 121 respectively include a terminal portion 1211 and a conductive portion 1212 connected to the terminal portion 1211. The terminal portion 1211 at least partially extends along the mating direction DM and is configured to abut opposite sides of a busbar. The second snapping portion 123 is disposed on the terminal portion 1211, and the conductive portion 1212 is connected between the second guiding portion 122 and the terminal portion 1211. For example, the conductive portion 1212 is secured between the second guiding portion 122 and the terminal portion 1211 by screws, but the present disclosure is not limited thereto.

Furthermore, as shown in FIG. 3, the terminal portion 1211 includes an outer terminal 1211a, an inner terminal 1211b and a conductive sheet 1211c. The conductive sheet 1211c is at least partially sandwiched between the outer terminal 1211a and the inner terminal 1211b. The outer terminal 1211a is connected with the conductive portion 1212, and the second snapping portion 123 is disposed on a side of the outer terminal 1211a facing away from the inner terminal 1211b. For example, the second snapping portion 123, the outer terminal 1211a, the conductive sheet 1211c and the inner terminal 1211b are secured to each other by screws, but the present disclosure is not limited thereto.

Additionally, as shown in FIG. 3, the second guiding portion 122 includes a first fixing member 1221 and at least one guiding member 1222 connected with the first fixing member 1221. The first fixing member 1221 is connected with the conductive portion 1212, and the guiding member 1222 at least partially extends along the mating direction DM. The guiding member 1222 is configured to be inserted into the limiting space SR defined by the limiting members 1121 of the insulating housing 110.

Furthermore, as shown in FIG. 3, the second snapping portion 123 includes a second fixing member 1231 and at least one elastic sheet 1232. The second fixing member 1231 is connected with the outer terminal 1211a of the terminal portion 1211. The elastic sheet 1232 has a fixed end 1232a and a free end 1232b opposite to the fixed end 1232a. The fixed end 1232a is connected with the second fixing member 1231, and the elastic sheet 1232 at least partially protrudes relative to the terminal portion 1211.

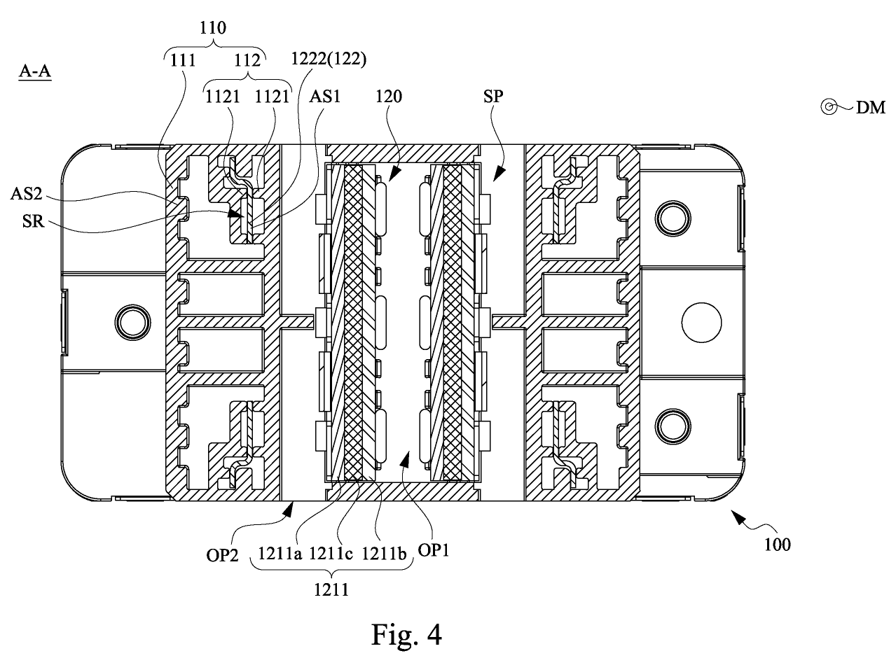

Please refer to FIG. 4. FIG. 4 is a sectional view along the sectional line A-A of FIG. 1. In this embodiment, as shown in FIG. 4, after the conductive component 120 is inserted into the insulating housing 110 along the mating direction DM, the guiding member 1222 of the second guiding portion 122 is at least partially located in the limiting space SR defined by the limiting members 1121 and abuts against the limiting members 1121. That is, during the insertion of the conductive component 120 into the insulating housing 110 along the mating direction DM, the limiting members 1121 of the insulating housing 110 guide the guiding member 1222 and thus the conductive component 120, thereby optimizing the installation convenience of the connector 100. Moreover, the conductive component 120 is at least partially restricted by the limiting members 1121 in a direction perpendicular to the mating direction DM, which enhances the structural stability of the connector 100.

Furthermore, as shown in FIG. 4, the outer casing 111 of the insulating housing 110 has a second cross-sectional profile AS2, and the guiding member 1222 of the conductive component 120 has a first cross-sectional profile AS1. Both of the first cross-sectional profile AS1 and the second cross-sectional profile AS2 are perpendicular to the mating direction DM. Specifically, the second cross-sectional profile AS2 of the outer casing 111 is at least partially shaped as a rectangular frame. The first guiding portion 112 of the insulating housing 110 is substantially located at the four corners of the second cross-sectional profile AS2, and at least partially aligned with the guiding member 1222 of the conductive component 120, facilitating the insertion of the guiding member 1222 into the limiting space SR of the first guiding portion 112. In addition, the first cross-sectional profile AS1 of the guiding member 1222 is at least partially bent in shape, providing the guiding member 1222 with improved structural strength and resistance to deformation.

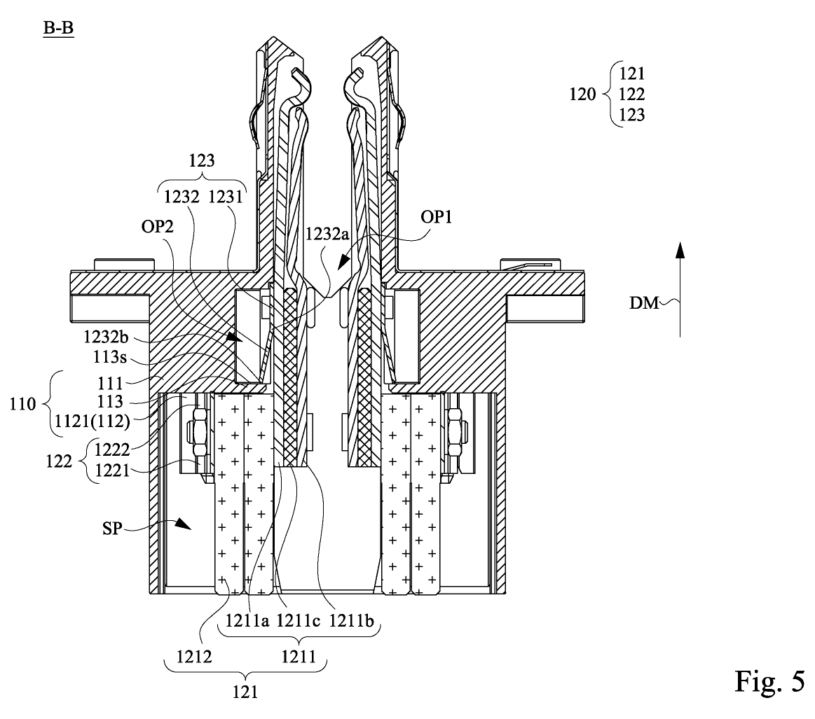

Please refer to FIG. 5. FIG. 5 is a sectional view along the sectional line B-B of FIG. 1. In this embodiment, as shown in FIG. 5, after the conductive component 120 is inserted into the insulating housing 110 along the mating direction DM, the conductive body 121 is at least partially located in the accommodation space SP of the insulating housing 110, and the terminal portion 1211 at least partially penetrates through the first opening OP1 of the insulating housing 110 along the mating direction DM. It is worth to note that, the first snapping portion 113 of the insulating housing 110 is plate-shaped and has an abutting surface 113s. The abutting surface 113s at least partially faces to the first opening OP1. During the insertion of the conductive component 120 into the insulating housing 110 along the mating direction DM, the elastic sheet 1232 of the second snapping portion 123 is pressed against the first snapping portion 113 of the insulating housing 110 to elastically deform, such that the free end 1232b of the elastic sheet 1232 is allowed to pass over the first snapping portion 113. After the free end 1232b passing over the first snapping portion 113, the elastic sheet 1232 elastically recovers and is suitable to abut against the abutting surface 113s of the first snapping portion 113, as shown in FIG. 5, such that the conductive component 120 is secured to the insulating housing 110 and prevented from being detached from the insulating housing 110. At this point, the conductive portion 1212 at least partially abuts against a side of the first snapping portion 113 opposite to the abutting surface 113s. Since the method of securing the conductive component 120 to the insulating housing 110 as mentioned above is simple and easy and does not require additional hand tools, it provides convenience to the user.

Please refer to FIGS. 1, 2, 4 and 5. In this embodiment, as shown in FIGS. 1, 2, 4 and 5, the outer casing 111 of the insulating housing 110 further has at least one second opening OP2. The second opening OP2 is communicated with the accommodation space SP and at least partially aligned with the elastic sheet 1232 of the conductive component 120. Thus, when disassembling the conductive component 120 from the insulating housing 110, a user can use a hand tool to pass through the second opening OP2 and press the elastic sheet 1232, causing the elastic sheet 1232 to elastically deform and allowing the free end 1232b to move close to the outer terminal 1211a of the terminal portion 1211, facilitating the free end 1232b to pass over the first snapping portion 113 and enabling separation of the conductive component 120 from the insulating housing 110.

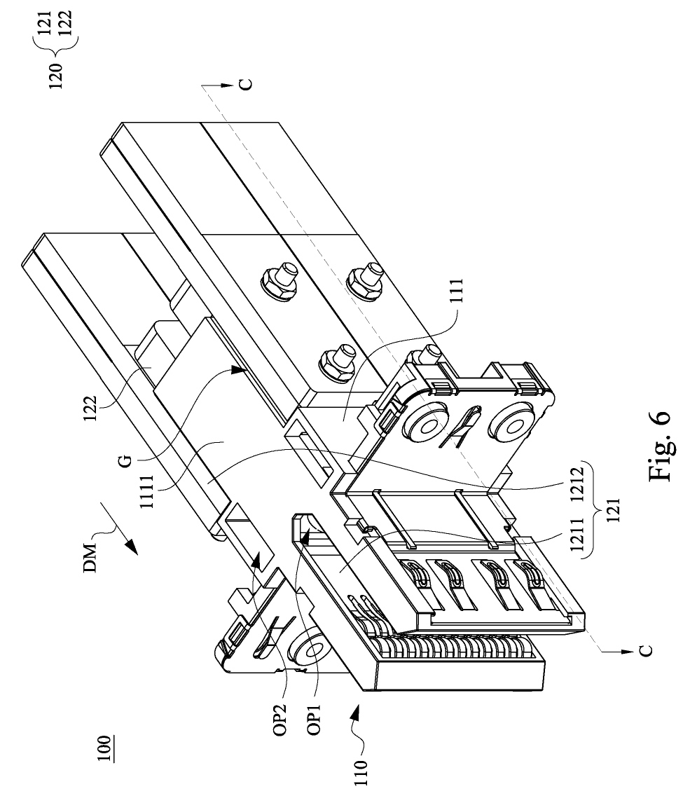

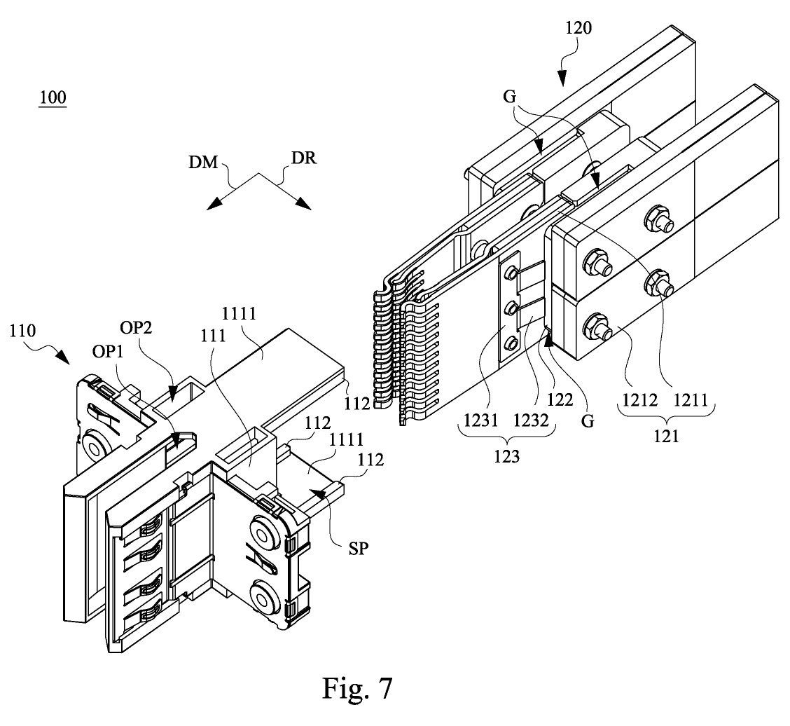

Please refer to FIGS. 6-7. FIG. 6 is a perspective schematic view of a connector 100 according to another embodiment of the present disclosure. FIG. 7 is a perspective schematic view of the connector 100 of FIG. 6, in which the insulating housing 110 and the conductive component 120 are separated from each other. In this embodiment, as shown in FIGS. 6-7, the first guiding portion 112 of the insulating housing 110 is strip-shaped, and the second guiding portion 122 of the conductive component 120 is at least partially connected between the terminal portion 1211 and the conductive portion 1212. For example, the second guiding portion 122 is at least partially sandwiched between the terminal portion 1211 and the conductive portion 1212 by screws, but the present disclosure is not limited thereto. It is worth to note that, the second guiding portion 122 has at least one groove G, and the first guiding portion 112 and the groove G at least partially extend along the mating direction DM respectively. After the conductive component 120 is inserted into the insulating housing 110 along the mating direction DM, the groove G of the second guiding portion 122 at least partially accommodates the first guiding portion 112. That is, during the insertion of the conductive component 120 into the insulating housing 110 along the mating direction DM, the first guiding portion 112 and the groove G provide guidance for the connection between the conductive component 120 and the insulating housing 110, thereby optimizing the installation convenience of the connector 100. Moreover, the conductive component 120 is at least partially restricted by the first guiding portion 112 in a direction perpendicular to the mating direction DM, enhancing the structural stability of the connector 100.

Furthermore, in this embodiment, as shown in FIG. 7, the outer casing 111 of the insulating housing 110 has two guiding plates 1111 disposed opposite and spaced apart from each other. The two guiding plates 1111 define the accommodation space SP aforementioned therebetween. In additional, a quantity of first guiding portion 112 and a quantity of the conductive component 120 (together with groove G) are respectively plural. Specifically, each of the two guiding plates 1111 is connected between two of the first guiding portions 112 along a limiting direction DR, .i.e., the two first guiding portions 112 are disposed on opposite edges of each of the two guiding plates 1111. The limiting direction DR is perpendicular to the mating direction DM. It is worth to note that, as shown in FIG. 6, after the insulating housing 110 and the conductive component 120 are connected to each other, the second guiding portion 122 of the conductive component 120 is at least partially located between the two guiding plates 1111, while the conductive portion 1212 of the conductive component 120 is located outside the outer casing 111 of the insulating housing 110. In other words, the size of the conductive portion 1212 is not limited by the outer casing 111. Thus, according to the actual situation, such as when a large current flows through the conductive component 120, a larger or thicker type of the conductive portion 1212 can be used.

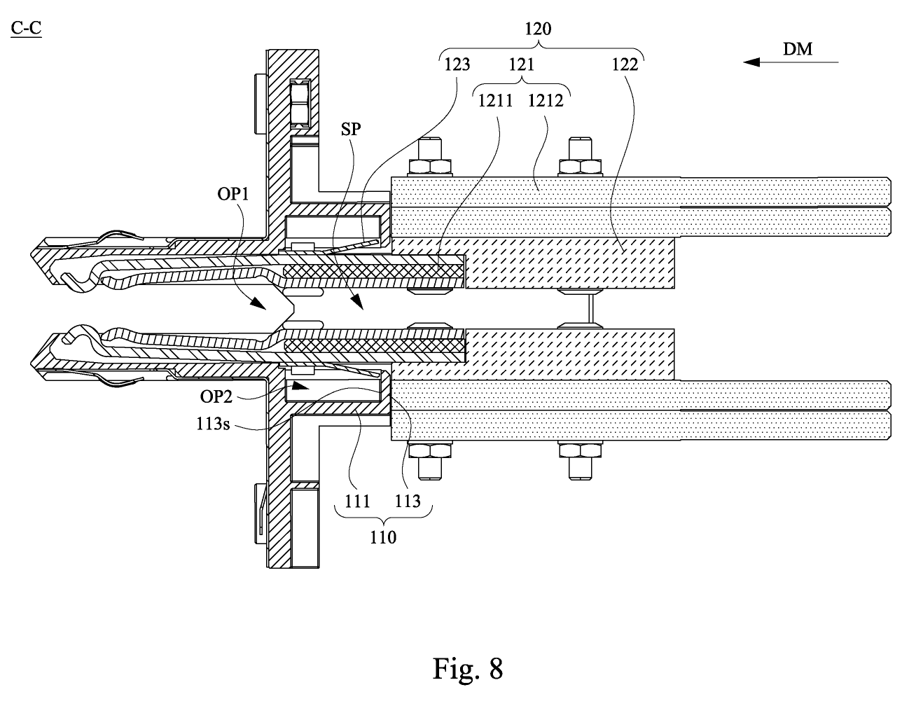

Please refer to FIG. 8. FIG. 8 is a sectional view along the sectional line C-C of FIG. 6. In this embodiment, as shown in FIG. 8, after the conductive component 120 is inserted into the insulating housing 110 along the mating direction DM, the second guiding portion 122 and the conductive portion 1212 of the conductive component 120 at least partially abut against a side of the first snapping portion 113 opposite the abutting surface 113s respectively.

In conclusion, the aforementioned embodiments of the present disclosure have at least the following advantages:

1 During the insertion of the conductive component into the insulating housing along the mating direction, the limiting members of the insulating housing guide the guiding member and thus the conductive component, thereby optimizing the installation convenience of the connector. Moreover, the conductive component is at least partially restricted by the limiting members in a direction perpendicular to the mating direction, which enhances the structural stability of the connector.

2 Since the method of securing the conductive component to the insulating housing is simple and easy, which is achieved by snapping with the first snapping portion of the insulating housing by the elastic sheet on the conductive component after deformation, and does not require additional hand tools, it provides convenience to the user.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector, comprising:
an insulating housing comprising an outer casing, at least one first guiding portion and at least one first snapping portion, the outer casing defining an accommodation space and a first opening communicated with the accommodation space, the first guiding portion and the first snapping portion being respectively connected to the outer casing; and
at least one conductive component comprising a conductive body, a second guiding portion and a second snapping portion, the conductive body being at least partially located in the accommodation space and penetrating through the first opening, the second guiding portion and the second snapping portion being respectively disposed on the conductive body, the second guiding portion being configured to couple with the first guiding portion, the second snapping portion being configured to snap with the first snapping portion.

2. The connector of claim 1, wherein the conductive body comprises a terminal portion and a conductive portion connected with the terminal portion, the terminal portion at least partially penetrates through the first opening, the second snapping portion is disposed on the terminal portion, the conductive portion is connected between the second guiding portion and the terminal portion.

3. The connector of claim 2, wherein the terminal portion at least partially extends along a mating direction and penetrates through the first opening along the mating direction, the first guiding portion and the second guiding portion at least partially extend along the mating direction respectively.

4. The connector of claim 3, wherein the first guiding portion comprises a plurality of limiting members located in the accommodation space and at least partially extending along the mating direction respectively, the limiting members collectively define a limiting space therein, the second guiding portion comprises a first fixing member and at least one guiding member connected with the first fixing member, the first fixing member is connected to the conductive portion, the guiding member at least partially extends along the mating direction, the guiding member is at least partially located in the limiting space and abuts against the limiting members.

5. The connector of claim 4, wherein the guiding member has a first cross-sectional profile perpendicular to the mating direction and at least partially bent in shape.

6. The connector of claim 4, wherein the first snapping portion is plate-shaped and connected to at least one of the limiting members, the first snapping portion has an abutting surface at least partially facing to the first opening, the second snapping portion comprises a second fixing member and at least one elastic sheet, the second fixing member is connected to the terminal portion, the elastic sheet at least partially protrudes relative to the terminal portion and has a fixed end and a free end opposite to the fixed end, the fixed end is connected to the second fixing member, the elastic sheet is configured to be pressed against the first snapping portion to elastically deform in order to allow the free end to pass over the first snapping portion and be suitable to abut against the abutting surface after passing over the first snapping portion.

7. The connector of claim 6, wherein the outer casing further comprises at least one second opening communicated with the accommodation space and at least partially aligned with the elastic sheet.

8. The connector of claim 2, wherein the terminal portion comprises an outer terminal, an inner terminal and a conductive sheet, the conductive sheet is at least partially sandwiched between the outer terminal and the inner terminal, the outer terminal is connected to the conductive portion, the second snapping portion is disposed on a side of the outer terminal facing away from the inner terminal.

9. The connector of claim 1, wherein the conductive component is configured to be at least partially inserted into the accommodation space along a mating direction and penetrate through the first opening, the outer casing has a second cross-sectional profile perpendicular to the mating direction and at least partially shaped as a rectangular frame, the first guiding portion is located within the second cross-sectional profile and at least partially aligned with the second guiding portion.

10. The connector of claim 1, wherein the conductive body comprises a terminal portion and a conductive portion, the terminal portion at least partially penetrates through the first opening along a mating direction, the second snapping portion is disposed on the terminal portion, the second guiding portion is at least partially connected between the terminal portion and the conductive portion and has at least one groove, the first guiding portion and the groove respectively extend along the mating direction, the groove is configured to at least partially accommodate the first guiding portion.

11. The connector of claim 10, wherein the first snapping portion is plate-shaped and has an abutting surface at least partially facing to the first opening, the second snapping portion comprises a second fixing member and at least one elastic sheet, the second fixing member is connected to the terminal portion, the elastic sheet at least partially protrudes relative to the terminal portion and has a fixed end and a free end opposite to the fixed end, the fixed end is connected to the second fixing member, the elastic sheet is configured to be pressed against the first snapping portion to elastically deform in order to allow the free end to pass over the first snapping portion and be suitable to abut against the abutting surface after passing over the first snapping portion.

12. The connector of claim 10, wherein the outer casing has two guiding plates opposite and spaced apart from each other, the two guiding plates define the accommodation space therebetween, a quantity of the first guiding portion and a quantity of the conductive component are respectively plural, each of the two guiding plates is connected between two of the first guiding portions along a limiting direction perpendicular to the mating direction, the second guiding portion of each of the conductive components is configured to be at least partially located between the two guiding plates, the conductive portion of each of the conductive components is configured to be located outside the outer casing.

13. A connector, comprising:
an insulating housing comprising an outer casing, at least one internal structure and at least one first guiding portion, the outer casing defining an accommodation space and an opening communicated with the accommodation space, the internal structure being connected with the outer casing and located in the accommodation space, the internal structure having a first side and a second side opposite to the first side, the internal structure forming a voided space at the first side, the first guiding portion being disposed on the second side; and
at least one conductive component comprising a conductive portion, a terminal portion, a second guiding portion and a snapping portion, the terminal portion and the second guiding portion being disposed on opposite sides of the conductive portion, the snapping portion being disposed on a side of the terminal portion facing to the second guiding portion, the conductive portion being located in the accommodation space and at least partially aligning with the internal structure along a mating direction, the terminal portion penetrating through the opening along the mating direction, the second guiding portion being configured to couple with the first guiding portion, the snapping portion being configured to be at least partially located in the voided space and elastically snapped with the internal structure.

14. The connector of claim 13, wherein the first guiding portion and the second guiding portion at least partially extend along the mating direction.

15. The connector of claim 13, wherein the snapping portion comprises a fixing member and at least one elastic sheet connected with the fixing member, the fixing member is connected with the terminal portion, the elastic sheet is connected with the fixing member and at least partially inclined relative to the terminal portion along the mating direction, the elastic sheet is located between the fixing member and the conductive portion, the elastic sheet is spaced apart from the conductive portion.

16. The connector of claim 15, wherein the elastic sheet is at least partially located between the terminal portion and the second guiding portion.
